(19) United States
(12) Patent Application Publication
(10) Pub. No.: US 2019/0191690 A1
(43) Pub. Date: Jun. 27, 2019

(54) AGENTS AND DEVICE FOR COMBATING PESTS, IN PARTICULAR RODENTS AND MICE, AND METHOD FOR USING THE AGENTS

(71) Applicant: KLAUS GASSER, GARGAZON (IT)

(72) Inventor: KLAUS GASSER, GARGAZON (IT)

(21) Appl. No.: 16/313,947

(22) PCT Filed: Jun. 30, 2017
(86) PCT No.: PCT/EP2017/066245

§ 371 Date: Dec. 28, 2018

(30) Foreign Application Priority Data
Jun. 30, 2016 (AT) A50589/2016
Oct. 20, 2016 (AT) A50956/2016

(51) Int. Cl. A01M 25/00; A01M 23/18; A01N 25/00; A01N 31/06

(52) U.S. Cl. CPC A01M 25/004; A01M 23/18; A01M 2200/00; A01N 31/06; A01N 25/004

(57) ABSTRACT

A product and a device for controlling pests is particularly suited for controlling rodents, such as mice. The product contains, or consists of, one or more active agents from the group of grayanotoxins in an effective amount.

The invention relates to a means for controlling pests, in particular rodents such as mice. Furthermore the invention relates to the application and use of the means for pest control and a device for applying this means using a bait box.

Rodents such as mice and rats are a synantropic species following humans and for example look for food directly in the places where foodstuffs are stored. Further, rodents like to dwell in areas used for food production, where they consume the field crops directly or cause damage to roots and tubers of the plants due to their underground way of life. In Indonesia for example, 17% of the rice harvest is lost due to rodents. All this leads to large-scale material damage, added to which is the collateral damage to insulation material, power lines, water pipes etc.

In addition to material damage caused by rodents, some species are also known as carriers of diseases and therefore pose a threat to humans. Bites can be instrumental in transferring, among others, pasteurellosis and rabies. Excrements from rodents can be instrumental in transferring salmonellosis and leptospirosis as well as haemorrhagic fever. The probably best known diseases such as murine typhus fever and the plague are those which are transferred by fleas living on rodents as parasites.

The control or at least containment of the rodent population is therefore an objective of pest control and also of the protection of plants and represents an important element of preventative hygiene.

Means for controlling mice using feed bait have been known for a considerable time. Widely known active agents are Curamins which, as anticoagulants from the group of vitamin-K-antagonists, inhibit the clotting of blood. These have the advantage that the toxic effect does not occur immediately after the take-in of food, but at a later time, when the affected rodents have retreated and therefore do not remain next to the feed bait.

The competent authorities meanwhile rate anticoagulants when used as rodenticides as very critical. On the one hand they may lead to resistance in the controlled rodent population. On the other environmentally dangerous properties may develop such as persistence or bio-accumulation. Further, due to internal bleeding in the animals it may cause serious animal suffering lasting several days. Moreover these active agents do not only affect rodents but also predators such as owls, common buzzards, golden eagles, foxes and polecats, for which mice are a substance of food. Furthermore seed and grain eating birds may also be affected if these eat these feed baits directly.

The present invention has set itself the task of proposing a reliably effective substance and a device for controlling pests such as mice, which substance is biological, originates from nature, is reliably effective and not, or merely to a limited extent, harmful to the environment. A further objective consists in that the means can be easily applied and that it is cheap.

The means according to the invention is characterised in that it contains one or more active agents from the group of grayanotoxins or consists thereof. The means can in addition to the active agent comprise a feed bait and/or an attractant for the rodent. The feed bait may be or may comprise an active agent tempting the rodent to orally consume the feed bait and the active agent.

In one variant the active agent with an active agent carrier is applied to a wipe-off surface in order to transfer the active agent to the skin or the fur of the rodent. In another variant the feed bait may be enclosed in a wrapping such as a little plastic bag consisting of nylon or a bio-plastic, which the rodent is able to open.

Furthermore the substance may be combined with an anticoagulant such as bromadiolone.

Preferably the means is characterised in that the active agent carrier is a substance selected from the group of natural oils, waxes and honey and their mixtures, emulsions, solutions and dispersions. Further preferably the active agent carrier may contain the following ingredients (%-by-weight):
sugar, preferably 60% to 85%, in particular approx. 80%,
organic acids, preferably 0.2%-0.8%, in particular approx. 0.6%,
enzymes, preferably 1%-3%, in particular approx. 2%-by-weight,
minerals, preferably potassium salt 0.1%-0.5%, in particular approx. 0.2%, and
water to 100%,
   as well as, as required, enticing additives such as scents, flavorings, preservatives, colorants, etc.

The grayanotoxin may also be contained as an active agent carrier in natural honey.

Preferably the grayanotoxin is contained in an amount of approx. 10 mg to 300 mg per kg active agent carrier, in particular honey.

The invention also relates to the use of a means as pest control substance, in particular as a rodent control substance. The application of the substance is characterised in that the substance is contained in a bait box, in particular as bait and/or on a wipe-off surface.

Preferably the bait box is constructed in such a way as to enable the pest to enter but, as required, prevent it from leaving. The bait may be designed for direct oral ingestion by the pest, in particular the rodent. Further, the bait and/or the wipe-off surface may be designed for indirect ingestion of the active agent by the pest, in particular by the rodent, in particular through oral ingestion during preening. The device for applying the substance is characterised in that the device comprises the substance according to the invention. The device may be designed as a bait box with a floor, sidewalls and a lid. Further, the device comprises at least one access hole for the pest to enter. The access hole may be equipped with a tilt door arrangement, which enables the pest to enter but not to leave.

Inside the bait box a container for receiving the substance, in particular the bait, is preferably provided. Inside the bait box a wipe-off surface may be provided, which is designed for indirect ingestion of the substance by the pest. In a further development of the invention the interior of the bait box may be protected against access by insects and small animals. Further, the bait box may comprise air holes, wherein, as required, the air holes are covered by a fine-mesh grid or fabric in order to prevent insects and small animals from entering. Preferably the bait box has a water-tight floor, and the air holes are arranged above the floor at a height sufficient to prevent the entry of water.

The means and the application may also comprise that the bait includes grains, pellets or paste to which the active agent with or without an additional active agent carrier is applied.

Furthermore it may be advantageous to condition the means as a spray or foam. The active agent carrier must then be formulated as a sprayable or foam-producing liquid. This enables the substance to be applied on contact surfaces or bait.

Further features are revealed in the claims and in the description.

Investigations and longer-lasting field trials have surprisingly revealed that the active agent, i.e. the grayanotoxin, is well suited as a rodenticide. The grayanotoxins have been described in exhaustive terms in literature and the chemical formulae are known. It has become evident that the effects of the substance occur even for low concentrations of the active agent. The lethal dose for grayanotoxin 1 in mice is approx. 5.1 mg per kg live weight and for grayanotoxin 3 approx. 4.9 mg per kg live weight. The substance as an active agent carrier may contain natural and/or synthetic carrier substances or substance mixtures. Natural carrier substances may be preferably selected from the group of natural oils, waxes and honey and their mixtures, emulsions, solutions or dispersions.

A preferred active agent carrier may contain the following ingredients (%-by-weight):
sugar, preferably 60% to 85%, in particular approx. 80%,
organic acids, preferably 0.2%-0.8%, in particular approx. 0.6%,
enzymes, preferably 1%-3%, in particular approx. 2%-by-weight,
minerals, preferably potassium salt 0.1%-0.5%, in particular approx. 0.2%, and
water to 100%,
active agent content as described above
   as well as, as required, enticing additives such as scents, flavorings, preservatives, colorants, etc.

The sugar content can be selected from the fructose, glucose, saccharide, disaccharide group. The organic acids are preferably selected from the glucose acid, citrus acid, malic acid, succinic acid and formic acid group, as well as the enzymes from the invertase, diastase, catalase, phosphatase, inhibin group. The mineral substance is preferably predominantly a potassium salt.

Grayanotoxins are found naturally in honey in areas rich in rhododendrons. The substance according to the invention may be this naturally found honey containing an amount of grayanotoxin. The grayanotoxin content may be subject to fluctuations, for example from 10 mg to 300 mg per kg of honey.

Experiments have shown that it is rare for mice to develop a resistance against grayanotoxin, which obviously is connected to the fact that the different variants of this active agent are aimed at different target receptors.

If found naturally the grayanotoxin is contained in an amount of approx. 10 mg to 300 mg per kg of honey. Moreover honey represents an attractant to mice which encourages ingestion. Furthermore carrier substances such as honey get caught in the rodent's fur so that the active agent can get into the body during preening of the fur.

Preferably the bait will be contained in a bait box. Bait boxes are widely known as mouse traps. They permit access to the rodent and prevent it from leaving. They prevent damage to the environment and from predators such as birds, foxes etc.

However it is also possible to deposit the bait with the active agent in the passageways of the rodents, or to apply it directly at the mouse hole.

The bait may be present in any suitable form such as e.g. for direct ingestion, e.g. in the form of cereal grains as bait grains, which have been coated with the active agent plus, as required, a carrier substance. If the grayanotoxin is contained in a sticky liquid such as honey, this can be applied to a surface as a wipe-off surface, which is licked off by the rodent or transferred to the fur, where it is orally ingested. Quantity-wise the bait has to be organised such that the rodent consumes a sufficient quantity, i.e. that it consumes at least the minimum lethal dose in order to ensure that it reliably perishes without prolonged suffering.

If the pest control substance shall be used in particular as a plant protection substance, protection is aimed above all at those plants, where the roots or the fruits which have formed, are eaten. In South Tyrol field trials have been carried out over an area of approx. 7 hectares of fruit farming with apple trees. The species of mice combatted were the common vole, water vole, field vole, bank vole and others. The active agent carrier used was honey with a content of grayanotoxin between 10 mg and 300 mg per kg honey. The grayanotoxins consisted predominantly of the grayanotoxin variants 1 and 3. But it is possible to use all variants 1 to 8 of grayanotoxin.

Apart from agricultural areas the substance according to the invention can also be used in storage areas, public parks, buildings etc.

Field trials lasting several years and carried out over an area of approx. 7 ha fruit farming, mainly apples, confirmed the effectiveness of the substance. No resistances whatsoever were found. The substance was placed in a bait box with a minimum quantity of 1 mg grayanotoxin which was applied to the outside of or inside the bait. The rodents were successful in gaining access to the bait box, even if this was enclosed in a pack consisting of plastic such as nylon, bio-plastic, paper, plastic of any given kind or gelatine capsules.

The substance was packed both in little bags and placed without wrapping into bait boxes. Application took the form of trials across all seasons from 2013 to May 2017. In almost 100% in all observed cases the rodents died within a short time.

No resistances were observed. The preferred active agent carrier was honey, with which the rodents ingested the substance in larger quantities. The rodents gained access to the substance even when it was contained in tight little bags made of a plastic foil (e.g. nylon). The fact that humans had been in contact with the bait did not have any negative impact. Even enwrapping it in three little bags did not deter the rodents from consuming the substance.

Combining the substance with bromadiolone both in a bait box and in mouse passages also produced the desired effect within a short time, wherein in the main the substance was consumed in conjunction with honey as the carrier, but less so with bromadiolone.

Preferably the substance is applied by means of a bait box into which an active agent pack was placed, which comprises the active agent in an appropriate quantity in the active agent carrier, such as honey. The active agent packs may for example be designed as little bags from the said materials and filled with the substance.

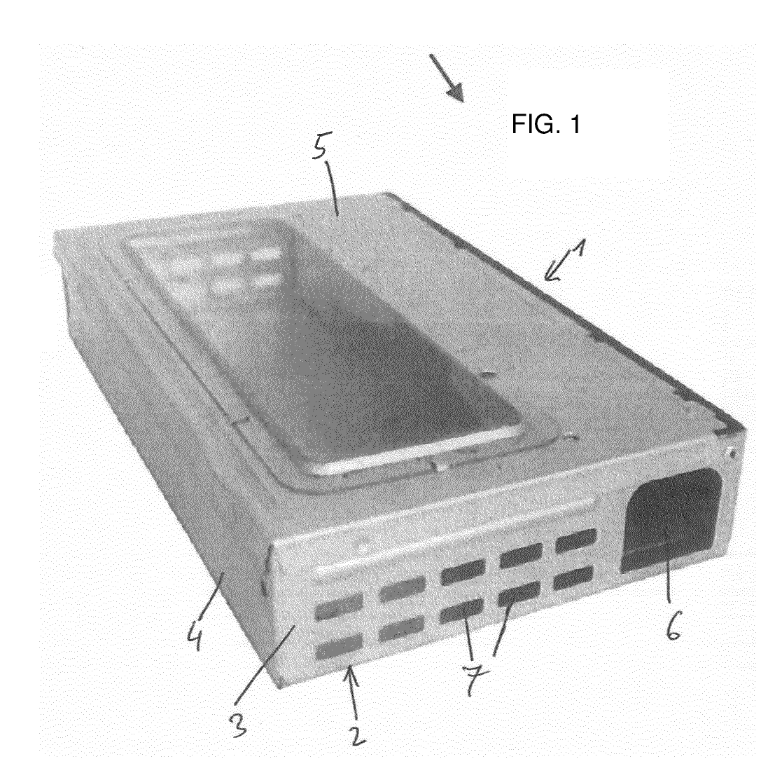

FIG. 1 shows a view of a bait box obliquely from the front.

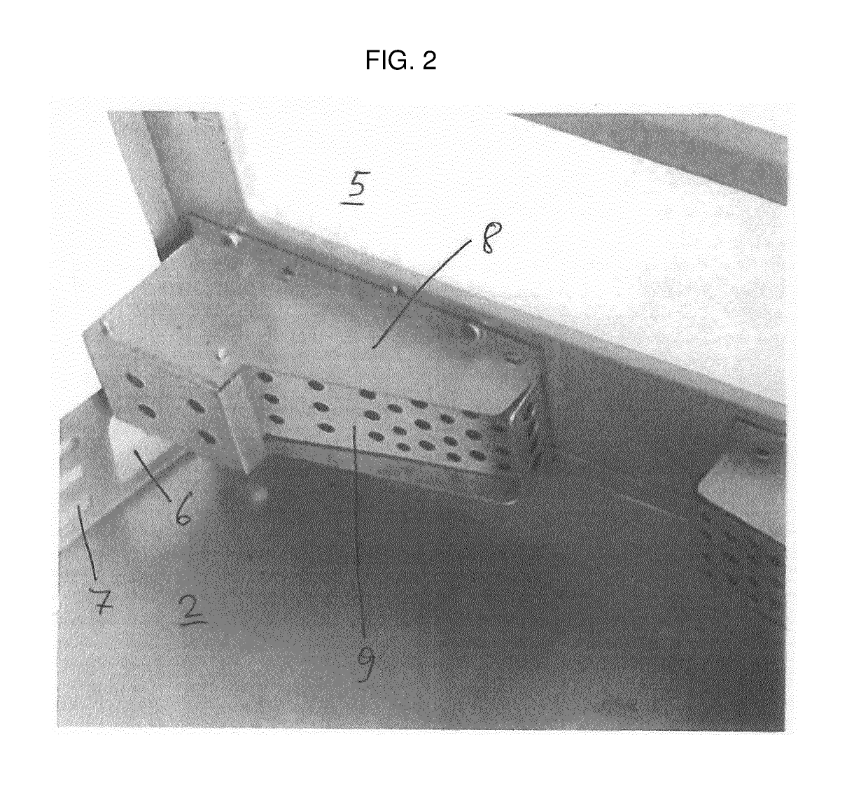

FIG. 2 shows an internal view of the tilt door of the bait box.

The bait box 1 is box-shaped with a floor 2, sidewalls 3, 4 and a lid 5, which is removable or pivotal, in order to allow access to the inside space.

The access hole 6 allows the animal access to the interior of the bait box. The air holes 7 allow the air to enter and are preferably covered by a close-meshed grating or fabric in order to prevent insects or small animals from gaining access.

The mesh size chosen for the grating or fabric must therefore be appropriately small.

FIG. 2 shows a tilt door arrangement 8 inside the bait box, in a position rotated by 90°.

The tilt door 9 functions like a trap door, which opens when the animal climbs up it and folds up again when the animal leaves the trap door in order to get to the bait inside the bait box 1.

In order to ingest the bait in the form of the active agent pack a bait container is preferably provided inside the bait box, into which the bait is placed and in which it can be exchanged. The air holes 7 of the bait box 1 are preferably arranged at a height above the floor 2 which is sufficient to prevent entry of water in case of rain. Practice has shown that a minimum distance of approx. 2 cm or higher is advantageous. The bait container in the bait box 1 may for this purpose also be arranged at a certain distance from the floor 2 so that the bait is kept away from water just in case a small amount of water gains entry.

It is thus ensured that the bait remains functional even in case of water penetration or that, in the worst case, the active agent does not get into the open. Easy maintenance of the bait box 1 is ensured.

The means with the active agent carrier such as honey may, for better handling, be filled into the above mentioned little bags as active agent pack and inserted closed into the bait box 1 or the bait container thereof.

The rodents open the bags and thus come into contact with the substance. The active agent pack may be opened by the operator. The substance may be in liquid form or be applied to a carrier substance.

1-28. (canceled)

29. A product for controlling pests, the product comprising:
a composition of one or more active agents from the group of grayanotoxins in an effective amount for controlling pests.

30. The product according to claim 29, further comprising an amount of feed bait and/or attractant for attracting a rodent.

31. The product according to claim 30, wherein the feed bait is or comprises an active agent carrier for enticing the rodent to orally ingest the feed bait and the one or more active agents.

32. The product according to claim 29, wherein the active agent, together with an active agent carrier, is applied to a wipe-off surface in order to transfer the active agent to the skin or the fur of a pest.

33. The product according to claim 30, further comprising a wrapping enclosing the feed bait with the agent and being openable by the rodent.

34. The product according to claim 29, further comprising an anticoagulant combined with the one or more active agents.

35. The product according to claim 29, further comprising an active agent carrier selected from the group consisting of natural oils, waxes, honey, and mixtures, solutions and dispersions thereof.

36. The product according to claim 35, wherein the active agent carrier comprises, in percent by weight:
60% to 85% sugar;
0.2%-0.8% organic acids;
1%-3% enzymes;
0.1%-0.5% minerals;
optional additives selected from the group consisting of scents, flavorings, preservatives, colorants; and
remainder water to 100%.

37. The product according to claim 29, further comprising natural honey being an active agent carrier containing the grayanotoxin.

38. The product according to claim 37, wherein the grayanotoxin is contained in an amount of approximately 10 mg to 300 mg per kg of the active agent carrier.

39. The product according to claim 29, further comprising a sprayable or foam-producing active agent carrier contained, together with the one or more active agents, in a spray container or a foam-producing container.

40. A pest control method, which comprises exposing the product according to claim 29 to pests such as rodents.

41. A pest control device, comprising the composition of claim 29 contained in a bait box in the form of feed bait and/or on a wipe-off surface of the bait box.

42. The pest control device according to claim 41, wherein the bait box is configured to enable access of the pest into the bait box and to prevent an exit of the pest from the bait box.

43. The pest control device according to claim 41, wherein the feed bait is configured for direct oral ingestion by the pest.

44. The pest control device according to claim 41, wherein the feed bait and/or the wipe-off surface is configured for indirect ingestion of the active agent by the pest, namely, for oral ingestion during preening.

45. The product according to claim 29, sprayed or foamed onto a contact surface or onto a feed bait.

46. A pest control device, comprising:
a bait box with a floor, sidewalls, and a lid; and
a composition of one or more active agents from the group of grayanotoxins in an effective amount for controlling pests.

47. The device according to claim 46, wherein the device is formed with at least one access opening for access of the pests to be caught.

48. The device according to claim 47, wherein the access opening is constructed with a tilt door arrangement configured to enable access by the pests and to prevent exit of the pests.

49. The device according to claim 46, further comprising a bait container for receiving the composition inside said bait box.

50. The device according to claim 46, wherein a wipe-off surface is formed inside said bait box, said wipe-off surface being configured for causing indirect ingestion of the composition by the pests.

51. The device according to claim 46, wherein an interior of said bait box is protected against entry by insects and small animals other than the pests.

52. The device according to claim 52, wherein said bait box is formed with air holes, and said air holes are covered by a fine-mesh grating or fabric in order to prevent insects and small animals from gaining access into said bait box.

53. The device according to claim 46, wherein said bait box is constructed with a water-tight floor.

54. The device according to claim 53, wherein said bait box is formed with the air holes arranged above the floor at a height sufficient to prevent water access.

55. The device according to claim 46, comprising bait grains, bait pellets or bait paste disposed in said bait box and having the active agent with or without additional active agent carrier applied thereon.
